(19) United States
(12) Patent Application Publication
(10) Pub. No.: US 2015/0237686 A1
(43) Pub. Date: Aug. 20, 2015

(54) CHROMOTHERAPY DEVICE

(71) Applicant: Curt D. Gilmore, Fenton, MI (US)

(72) Inventor: Curt D. Gilmore, Fenton, MI (US)

(21) Appl. No.: 14/181,799

(22) Filed: Feb. 17, 2014

(51) Int. Cl. H05B 33/08

(52) U.S. Cl. CPC H05B 33/0803

(57) ABSTRACT

A chromotherapy device for providing chromotherapy capabilities in a vessel that is configured to contain water. The chromotherapy device is relatively inexpensive and eliminates the risk of water leakage through the vessel that is associated with the provision of chromotherapy capabilities in a conventional manner (e.g., through one or more hole in the vessel through which a waterproof light fixture is installed).

### FIELD

The present disclosure relates to a chromotherapy device.

### BACKGROUND

This section provides background information related to the present disclosure which is not necessarily prior art.

Chromotherapy is intended to be a therapeutic and relaxing experience/treatment that is increasingly being incorporated into bathing/showering fixtures such as bathtubs. Chromotherapy capabilities can be incorporated into an otherwise conventional bathtub via waterproof light fixtures that are mounted through holes in the bathtub that are located below the waterline. The waterproof light fixtures employ lamps that are typically powered by line voltage AC circuits and as such, various transformers, ground fault interrupters, etc. are required in the circuitry to prevent the possibility of electrical shock. The provision of chromotherapy capabilities in this manner is relatively expensive and carries a risk of water leakage through the bathtub (i.e., through the hole in the bathtub through which the waterproof light fixture is installed). Moreover, it can be difficult and/or inconvenient to retrofit a conventional bathtub with conventionally provided chromotherapy capabilities. Accordingly, there remains a need in the art for an improved chromotherapy device.

### SUMMARY

This section provides a general summary of the disclosure, and is not a comprehensive disclosure of its full scope or all of its features.

In one form, the present teachings provide a chromotherapy device for use in a vessel that is configured to contain water. The chromotherapy device includes a first device portion and a second device portion. The first device portion has a flexible mat and a light array. The light array is coupled to the flexible mat and includes a plurality of LED devices. Each LED device has one or more LED's and is configured to selectively generate visible light of a first color, a second color and a third color. The second device portion has a battery receptacle that is configured to hold at least one battery. The battery receptacle has a pair of receptacle terminals that are electrically coupled to the light array. The LED devices and an electrical connection between the first and second devices are waterproof.

In another form, the present teachings provide a chromotherapy device for a vessel that is configured to hold water. The chromotherapy device includes a flexible mat, a light array and a power unit. The light array is coupled to the flexible mat and includes a plurality of LED devices. Each LED device has one or more LED's and is configured to selectively generate visible light of a first color, a second color and a third color. The power unit has a coil, a rectifier and a voltage regulator. The power unit is coupled to the mat and configured to produce DC electric power when the coil is positioned in a magnetic field so as to be part of an air core transformer. The LED devices and an electrical connection between the power unit and the LED devices are waterproof.

In still another form, the present teachings provide a chromotherapy accessory for hanging from a shower curtain rod. The chromotherapy accessory includes a light array, a battery receptacle and a hanger. The light array includes a plurality of LED devices. Each LED device has one or more LED's and is configured to selectively generate visible light of a first color, a second color and a third color. The battery receptacle is mounted to the light array and is configured to hold at least one battery. The battery receptacle has a pair of receptacle terminals that are electrically coupled to the light array. The hanger is mounted to the battery receptacle so as to extend from the battery receptacle on a side that is opposite the light array. The hanger is configured to be mounted on the shower curtain rod. The LED devices and an electrical connection between the battery receptacle and the light array are waterproof.

In yet another form, the present teachings provide a chromotherapy curtain for shrouding a showering area. The chromotherapy curtain includes a curtain, a light array and a battery receptacle. The curtain defines a plurality of spaced-apart holes disposed proximate a top edge of the curtain. The light array is coupled to the curtain and includes a plurality of LED devices. Each LED device has one or more LED's and is configured to selectively generate visible light of a first color, a second color and a third color. The battery receptacle is configured to hold at least one battery and includes a pair of receptacle terminals that are electrically coupled to the light array. The LED devices and an electrical connection between the battery receptacle and the light array are waterproof.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a first chromotherapy device constructed in accordance with the teachings of the present disclosure, the first chromotherapy device being illustrated in operative association with a vessel;

FIG. 2 is an enlarged perspective view of the chromotherapy device of FIG. 1;

FIG. 3 is a plan view of a portion of the chromotherapy device of FIG. 1 illustrating a light array and a controller in more detail;

FIG. 4 is a perspective view of a portion of the light array and the controller that are illustrated in FIG. 3;

FIG. 5 is a perspective view of a second chromotherapy device constructed in accordance with the teachings of the present disclosure;

FIG. 6 is an exploded perspective view of a portion of the chromotherapy device of FIG. 1 illustrating a battery receptacle in more detail;

FIG. 7 is a section view of a portion of another chromotherapy device constructed in accordance with the teachings of the present disclosure, the chromotherapy device having a light array that is mounted to an exterior surface of a flexible mat;

FIG. 8 is a perspective view of a portion of the controller that is illustrated in FIG. 3;

FIG. 9 is a perspective view of a remote control unit in operative association with the controller illustrated in FIG. 3;

FIG. 10 is a perspective view of a fourth chromotherapy device constructed in accordance with the teachings of the present disclosure;

FIG. 11 is a schematic illustration of a fifth chromotherapy device constructed in accordance with the teachings of the present disclosure;

FIG. 12 is a schematic illustration of a sixth chromotherapy device constructed in accordance with the teachings of the present disclosure;

FIG. 13 is a section view of the chromotherapy device of FIG. 12, the chromotherapy device being depicted in operative association with a vessel and a primary coil of an air-core transformer;

FIG. 14 is a perspective view of the chromotherapy device of FIG. 12, the chromotherapy device being depicted in operative association with a vessel and a primary coil of an air-core transformer;

FIG. 15 is a perspective view of a seventh chromotherapy device constructed in accordance with the teachings of the present disclosure;

FIGS. 16 and 17 are right and front side views, respectively, of the chromotherapy device of FIG. 15; and

FIG. 18 is a perspective view of an eighth chromotherapy device constructed in accordance with the teachings of the present disclosure.

### Corresponding reference numerals indicate corresponding parts throughout the several views of the drawings.

### DETAILED DESCRIPTION

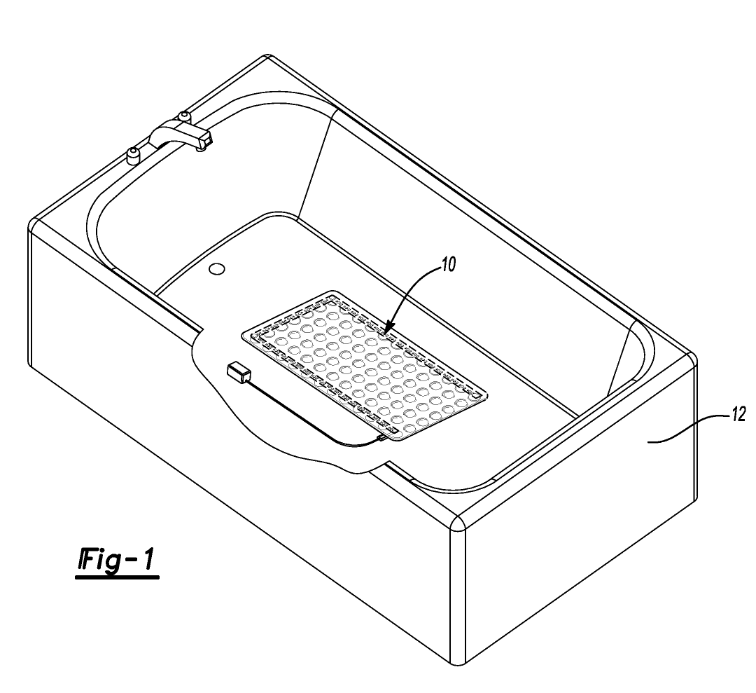

With reference to FIG. 1 of the drawings, a first chromotherapy device constructed in accordance with the teachings of the present disclosure is generally indicated by reference numeral 10. The chromotherapy device 10 is illustrated in operative association with a vessel 12 that is configured to hold water. In the particular example provided, the vessel 12 is a bathtub, but those of skill in the art will appreciate that other devices, including vats, pools, troughs, etc. that are configured to hold water.

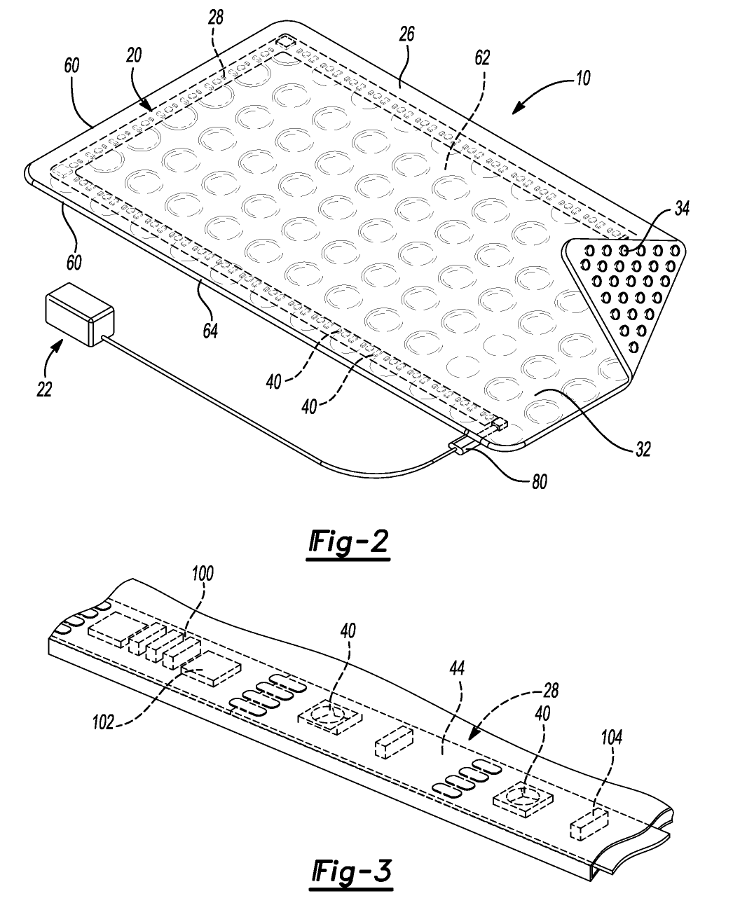

With additional reference to FIG. 2, the chromotherapy device 10 can comprise a first device portion 20 and a second device portion 22. The first device portion 20 can include a flexible mat 26 and a light array 28. The flexible mat 26 can be formed of any suitable material, such as a clear or translucent plastic material. If desired, the material can have a specific gravity that is greater than 1.0 and can be non-porous so as to not absorb a significant amount of water when the first device portion 20 is submersed in water in the vessel 12. The flexible mat 26 can be shaped in any manner desired, such as an oval or rectangular shape, and can include a mat body 32 and one or more non-skid features 34 that can be coupled to the mat body 32 and configured to resist sliding motion of the first device portion 20 relative to the vessel 12 when the chromotherapy device 10 is in use. In the particular example provided, the non-skid features 34 comprise a plurality of suction cup structures that are integrally formed with the mat body 32, but it will be appreciated that other devices, such as one or more magnets, could be employed to resist movement of the flexible mat 26 relative to the vessel 12.

With reference to FIGS. 2 through 4, the light array 28 can comprise a plurality of light emitting diode (LED) devices 40 that can each have one or more LED's 42 that can be selectively operated to generate visible light of a first color, a second color and a third color. In a particular example provided, the LED devices 40 are mounted to a flexible circuit board 44 and each of the one or more LED's 42 comprises a red element 50 (e.g., a red LED), a green element 52 (e.g., a green LED) and a blue element 54 (e.g., a blue LED) that can be selectively operated as will be described in more detail below. The light array 28 can be physically coupled to the flexible mat 26 in any desired manner. For example, the light array 28 can be mounted or attached to an exterior surface of the mat body 32 or could be molded into the mat body 32 (i.e., the mat body 32 is overmolded onto the light array 28 such that the light array 28 is at least partly encapsulated in the mat body 32). In the particular example provided, however, the mat body 32 has a pair of wall members 60, which cooperate defines an interior cavity 62 into which the light array 28 is received, and a closure device 64 is employed to sealingly couple the wall members 60 to one another to render the interior cavity 62 waterproof. In some embodiments, the closure device 64 could be configured to permanently and sealingly couple the wall members 60 to one another, which would inhibit further access to the interior cavity 62, or could be configured to sealingly but releasably couple the wall members 60 to one another, which would permit access to the interior cavity 62. Examples of a closure device 64 of the former type include welds and bonds, and examples of a closure device 64 of the latter type include zippers 65 (FIG. 5).

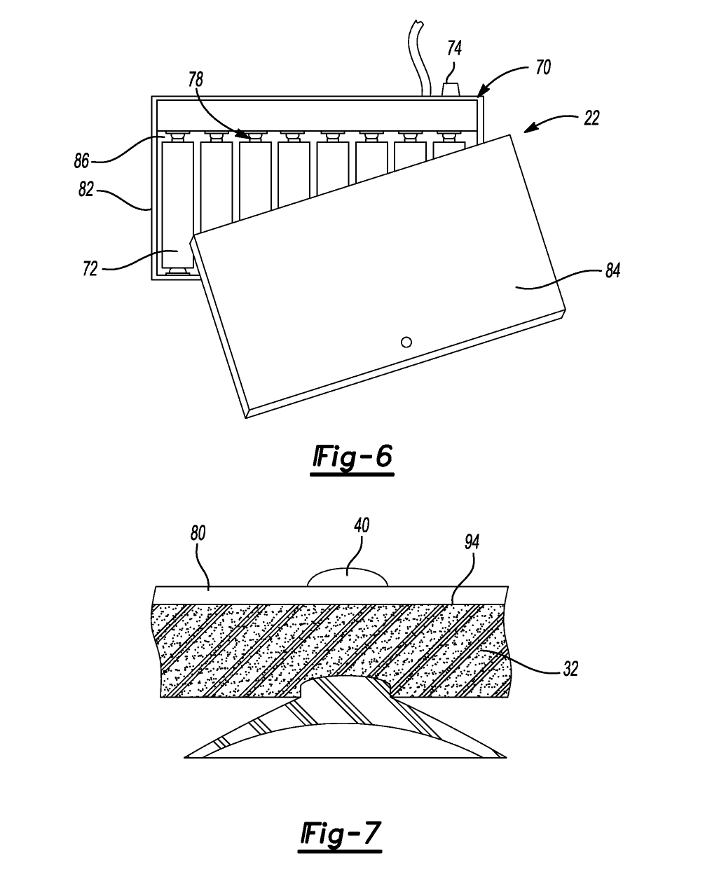

With reference to FIGS. 2 and 6, the second device portion 22 can have a battery receptacle 70, which is configured to hold at least one battery 72, and an on-off switch 74. The at least one battery 72 can have a relatively low voltage output, such as 6VDC (the light array 28 and other electronics could be configured to operate on 5VDC electrical power, for example). The battery receptacle 70 can have a pair of receptacle terminals 78 that are electrically coupled to the light array 28 via an electrical connection 80. In its most basic form, the second device portion 22 is the pair of receptacle terminals 78. Configuration in this manner may be desirable when the second device portion 22 is received directly into the interior cavity 62. The battery receptacle 70 in the particular example provided includes first and second receptacle portions 82 and 84, respectively, that cooperate to define a battery cavity 86 that is configured to hold the battery 72. The first and second receptacle portions 82 and 84 can be releasably coupled to one another to permit a user to access the battery cavity 86, for example to replace the battery 72. Alternatively, the first and second receptacle portions 82 and 84 can be permanently coupled to one another. The first and second receptacle portions 82 and 84 can be sealingly engaged/engagable to one another to render the battery receptacle at least water resistant and preferably waterproof. As used herein, the term “water resistant” means being capable of submersion in up to one foot of water for up to one-half hour without the water completely penetrating the item and the term “waterproof” means being capable of submersion in up to 6 feet (2 meters) for up to twenty-four hours without the water completely penetrating the item. The electrical connection 80 can comprise a pair of electric conductors 90, such as wires. The on-off switch 74 can be employed to selectively interrupt the transmission of electrical power from the at least one battery 72 to the electrical connection 80.

The LED devices 40 and the electrical connection 80 between the first and second device portions 20 and 22 are waterproof. In the example of FIG. 5, the LED devices 40 and the electrical connection 80 are disposed within the mat body 32 of the flexible mat 26. In the example of FIG. 7, the LED devices 40 are fixedly coupled to an exterior surface 94 of the mat body 32 and the LED devices 40 and the electrical connection 80 are themselves waterproof.

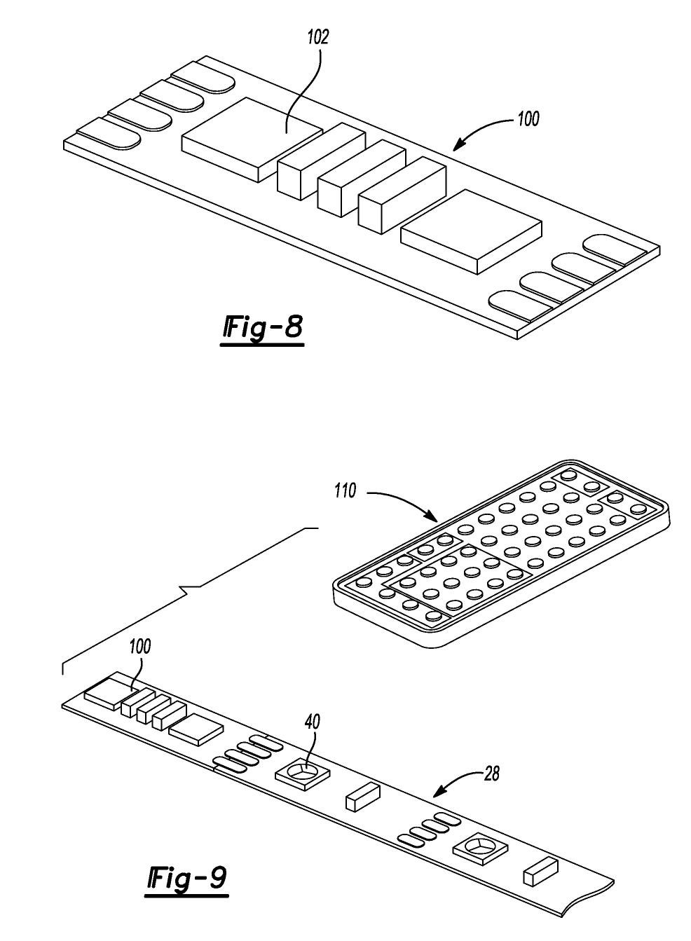

With reference to FIGS. 2, 3, 4 and 8, the chromotherapy device 10 can optionally include a controller 100, which can be configured to control the color of the light produced by the LED devices 40 and/or the amount of light produced by the LED devices 40. The controller 100 can be mounted to the circuit board 44 and can be electrically coupled to the receptacle terminals 78 (FIG. 6) and the light array 28. In one form, the controller 100 is configured to operate the LED devices 40 on an individual basis so that one LED device 40 can be operated independent of the other LED devices 40. Configuration in this manner permits the light array 28 to be operated in several modes, each of which controlling the color of the light produced by the LED devices 40 and the intensity of the light produced by the LED devices 40. In the particular example provided, the controller 100 includes a main controller 102 and a plurality of sub-controllers 104, each of which being coupled to the main controller 102 a corresponding one of the LED devices 40. Each of the sub-controllers 104 that receives digital commands from the main controller 102. The commands from the main controller 102 controls (i.e., regulates) power that the sub-controller 104 provides to each of the red, green and blue elements 50, 52 and 54 in an LED device 40 on an individual basis. For example, a pulse width modulation technique could be employed to control each of the red, green and blue elements 50, 52 and 54 to provide light of a desired color and/or to control the intensity of illumination provided by the light array 28.

For example, red light could be produced using a non-zero duty cycle to power the red element 50 and a zero duty cycle for the green and blue elements 52 and 54. Combinations of two of the red, green and blue elements 50, 52 and 54 or all of the red, green and blue elements 50, 52 and 54 can be operated with non-zero duty cycles to produce light of different colors. For example, using equal and non-zero duty cycles (e.g., a 100% duty cycle) to power the red and blue elements 50 and 54 while the green element 52 is not powered (i.e., a zero duty cycle is employed for the green element 52) will cause the LED device 40 to output purple light. As another example, using equal and non-zero duty cycles for each of the red, green and blue elements 50, 52 and 54 will cause the LED device 40 to output approximately white light.

It will be appreciated that the magnitude of the non-zero duty cycles need not be equal (so as to permit further variation in the color of the light that is produced) and that the magnitude of the non-zero duty cycle(s) can be selected to vary the magnitude of the total light produced by each LED devices 40 (i.e., so that the LED devices 40 are “dimmable”).

It will be appreciated that the controller 100 can be preprogrammed to cause the light array 28 to output light of various pre-programmed colors and/or to operate the LED devices 40 according to various flashing routines, rolling intensity schemes, and/or color patterns.

It will be appreciated that although the LED devices 40 have been described as being controllable by the controller 100 on an individual basis, the controller 100 could be configured to control groups of the LED devices 40 in a similar manner and/or to control all of the LED devices 40 in a similar manner. In the former alternative, the groups of the LED devices 40 controlled by the controller 100 could form lines, such as a rows or columns, or one or more geometric shapes, such as circles, stars, or diamonds. The LED devices 40 could be coupled to the controller 100 on an individual basis (e.g., as described above or via discrete wires), which permits the controller 100 to change the grouping of the LED devices 40 in a predetermined manner, or each of the groups of LED devices 40 could be coupled to the controller 100 as a set so that their grouping cannot be changed and the LED devices 40 cannot be operated on an individual basis. As yet another alternative, the controller 100 could be configured to operate all of the LED devices 40 as a single group. The LED devices 40 could be coupled to the controller 100 on an individual basis (e.g., as described above or via discrete wires), which permits the controller 100 to change the grouping of the LED devices 40 in a predetermined manner, or the LED devices 40 could be coupled to the controller 100 as a set so that their grouping cannot be changed and the LED devices 40 cannot be operated on an individual basis or in a plurality of groups.

With reference to FIG. 9, an optional remote control unit 110 could be employed to wirelessly transmit (e.g., via infrared or radio frequency signals) one or more user commands to the controller 100 to cause the controller 100 to operate in one of a plurality of modes of operation. In its most basic form, the modes of operation include an OFF mode, in which the light array 28 is not operated, and an ON mode in which the light array 28 is operated in a predetermined manner. Other modes of operation or user-selectable settings within a mode could permit the user to select light of one or more selected colors of light that are to be produced by the light array 28, to select a speed at which a pattern of light produced by the light array 28 is changed, and/or to select a magnitude of the light output by the light array 28. In embodiments where the controller 100 permits operation of the LED devices 40 in groups or on an individual basis, the modes of operation could permit the user to select a pattern of light that is produced by the light array 28, to select light of one or more selected colors of light that are to be produced by the light array 28, to select a speed at which a pattern of light produced by the light array 28 is changed, and/or to select a magnitude of the light output by the light array 28.

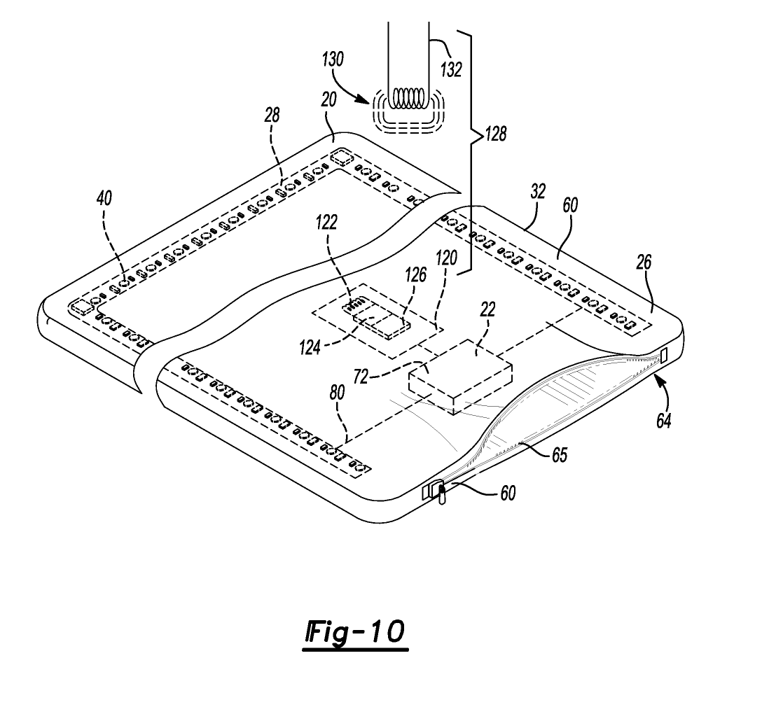

The example of FIG. 10 is generally similar to that of FIG. 1, except that the battery 72 is a rechargeable battery and the second device portion 22a additionally comprises a power unit 120 having a coil 122, a rectifier 124 and a voltage regulator 126. The power unit 120 can be electrically coupled to the battery 72 and is configured to inductively produce DC electric power (i.e., to recharge the battery 72 and/or to power the light array 28) when the coil 122 is positioned in a magnetic field 130 so as to be part of an air-core transformer 128. It will be appreciated that the coil 122 can be the secondary coil of the air-core transformer 128 and that the magnetic field 130 can be produced by a second coil 132, which can be the primary coil of the air-core transformer 128. The second (primary) coil 132 can be housed in any desired structure, such as a storage device 134 that is employed to store the first and second device portions 20 and 22a when they are not in use. The storage device 134 can be any type of device that is configured to house or hold the first and second device portions 20 and 22a when they are not in use. For example, the storage device 134 can be a towel bar onto which the first and second device portions 20 and 22a can be suspended.

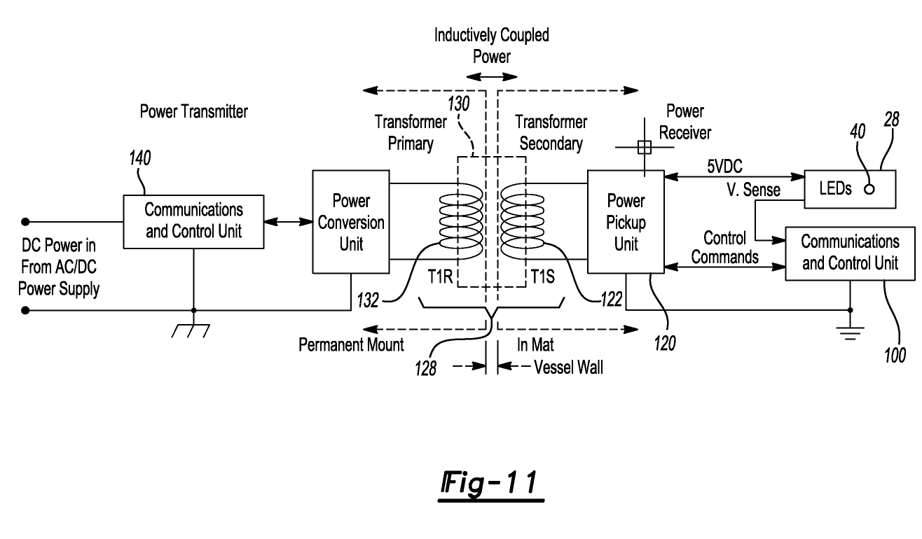

Optionally, an air-core transformer controller 140 can be employed to control power to the second (primary) coil 132 as shown in FIG. 11. In one form, the air-core transformer controller 140 can be configured to cycle power to the second (primary) coil 132 on a periodic basis and to look for a signal produced by the power unit 120 when the (secondary) coil 122 is disposed in the magnetic field 130.

In this regard, elements within the air-core transformer controller 140 and the controller 100 can be configured similar to the Freescale Semiconductor 56F824X-56F825X family of digital signal controllers and the Freescale Semiconductor 9S08P family of micro controllers, respectively, in which the air-core transformer controller 140 causes power to be applied to a primary coil of an air-core transformer (i.e., the air-core transformer 128, or an optional second, smaller air-core transformer that can reside in the elements of the air-core transformer controller 140 and the controller 100) at regular intervals for short periods of time to inject a query via communications superimposed on induced power waveforms. The element within the air-core transformer controller 140 (i.e., the transmitter) is continuously asking via wireless transmitted bursts if there are any receivers (i.e., element within the controller 100) that are in close physical proximity to the transmitter. This is done in such a way at to begin transmitting magnetic induction waves to temporarily power up any receivers within range, then listening for any “I am here” types of messages from the receiver. As soon as the receiver has enough induced power to turn on, it immediately tells the transmitter via wireless serial communications that it is here and requires power. The dialogue used between the transmitter and receiver allows the transmitter to remain effectively “off” until a receiver identifies itself. Once the two acknowledge each others existence, the receiver communicates back to the transmitter how much power it requires to power its load with a controlled output voltage.

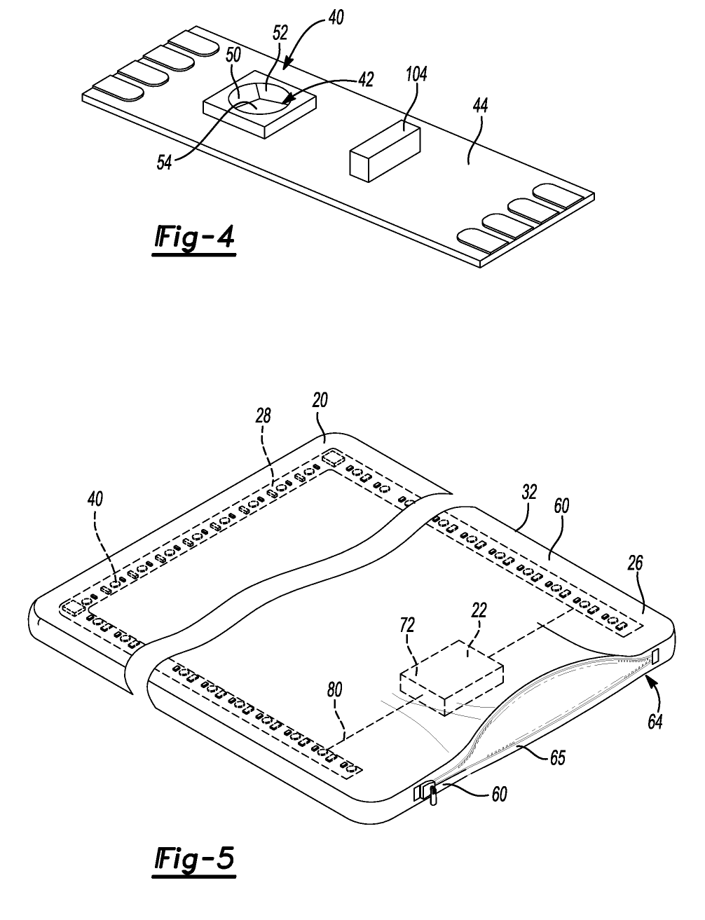

With reference to FIGS. 4 and 11, the amount of power required for operation of the light array 28 can vary depending on the duty cycles associated with the red, green and blue elements 50, 52 and 54 for the LED devices 40. For example, more power is consumed if all of the LED devices 40 are operated to produce high intensity “white” light as compared to a situation in which a portion of the LED devices 40 are operated to produce lower intensity light of a single “primary” color (e.g., red, green or blue light in which only one of the red, green and blue elements 50, 52 and 54 has a non-zero duty cycle) and the remaining LED devices 40 are controlled with a zero duty cycle (i.e., not illuminated). Accordingly, the receiver can regulate its output voltage by requesting a level of power that is coordinated with the operation of the light array 28 (e.g., a higher level of power could be requested when all of the LED devices 40 are operated at a 100% duty cycle to produce “white” light, and a lower level of power could be requested when all of the LED devices 40 are operated at a 100% duty cycle to produce light of a primary color). There are two significant standards being considered for use at this time. The Qi Medium power or the A4WP standard may be selected to control air-coupled power, depending on which one is commercially available and most cost effective.

Returning to FIG. 10, the air-core transformer controller 140 can additionally or alternatively be configured to power the second (primary) coil 132 based on an input generated by the user. The user-generated input could be generated via a manual push-button (not shown) that is operated by the user to control or initiate the application of power to the second (primary) coil 132 and/or could be generated by a switch (not shown), such as a limit switch or a proximity switch, that is activated when the first and second device portions 20 and 22a are placed in a predetermined position relative to the storage device 134.

While the (secondary) coil 122 has been depicted as residing within the mat body 32, those of skill in the art will appreciate that it could reside outside the mat body 32 and be coupled to the light array 28 in a manner that is similar to the coupling of the battery receptacle 70 to the light array 28. Configuration in this manner may be desirable in situations where the chromotherapy device 10a does not include a battery and the air-core transformer 128 is employed to power the light array 28.

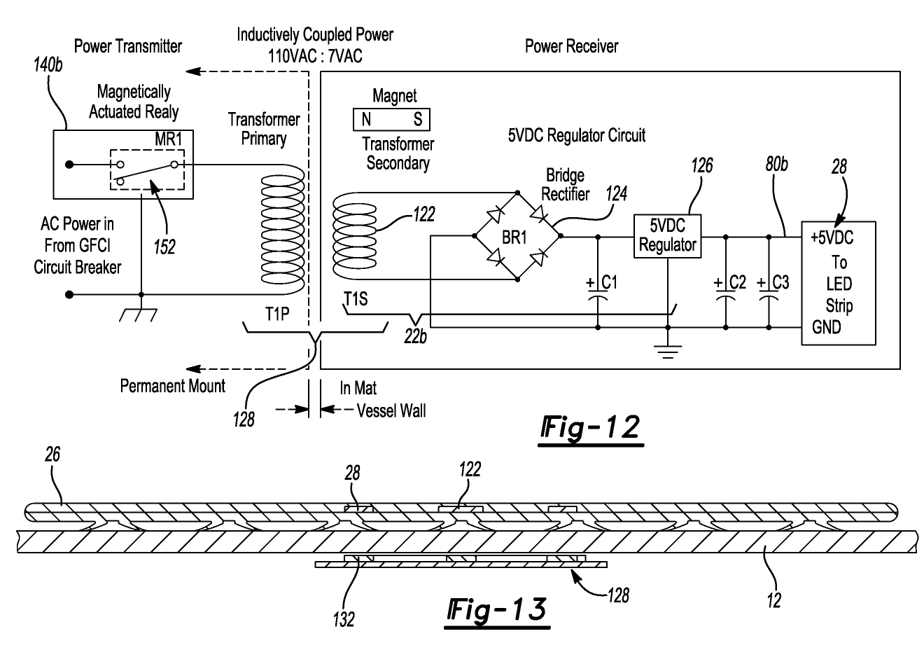

The example of FIGS. 12 and 13 can be generally similar to the embodiment of FIG. 10, except that the second device portion 22b comprises the coil 122 and the power unit 120 (i.e., the battery and battery receptacle are optional and can be omitted). The light array 28 can be directly electrically coupled to the power unit 120 to receive electrical power therefrom and the electrical connection 80b between the power unit 120 and the light array 28 can be waterproof. The second (primary) coil 132 of the air-core transformer 128 can be mounted to the underside 150 of the vessel 12. It will be appreciated that in this embodiment, the vessel 12 is formed of an electrically insulating material so that it does not interfere with the operation of the air-core transformer 128.

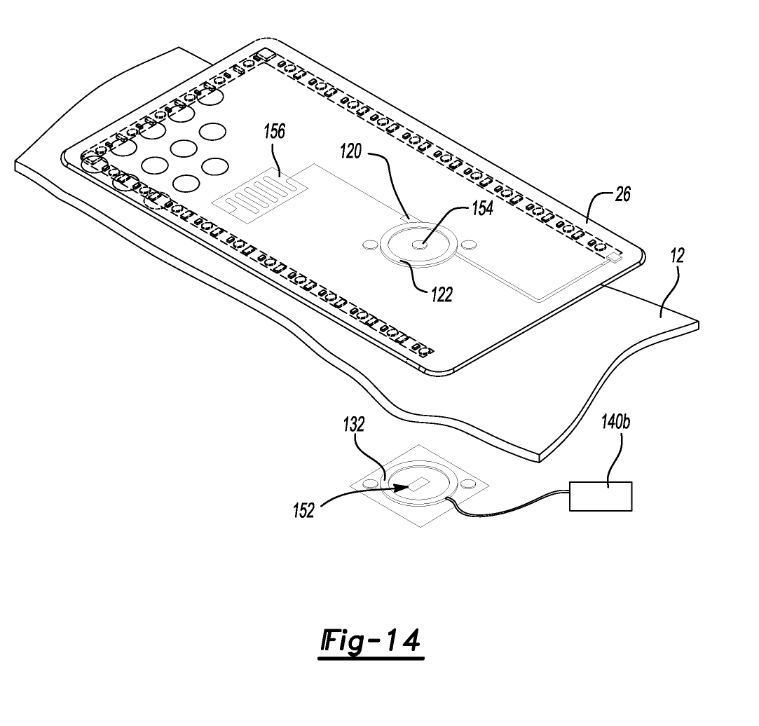

With reference to FIGS. 12 and 14, the air-core transformer controller 140b can comprise a relay 152 that is configured to selectively de-couple the second (primary) coil 132 from a source of electrical power. The relay 152 can be a magnetically-actuated relay and optionally, one or more magnets 154 can be coupled to the flexible mat 26 to operate the magnetically-actuated relay when the flexible mat 26 is positioned in a predetermined manner relative to the vessel 12.

It will be appreciated that in each of the above-described embodiments that operation of the light array 28 will generate heat, which can be rejected to the water in the vessel 12 to provide supplemental water heating. Any of the above-described embodiments could additionally include a heating element 156 (FIG. 14) that is coupled to a source of electrical power, such as a battery or the (secondary) coil 122 (FIG. 14) and the power unit 120 (FIG. 14).

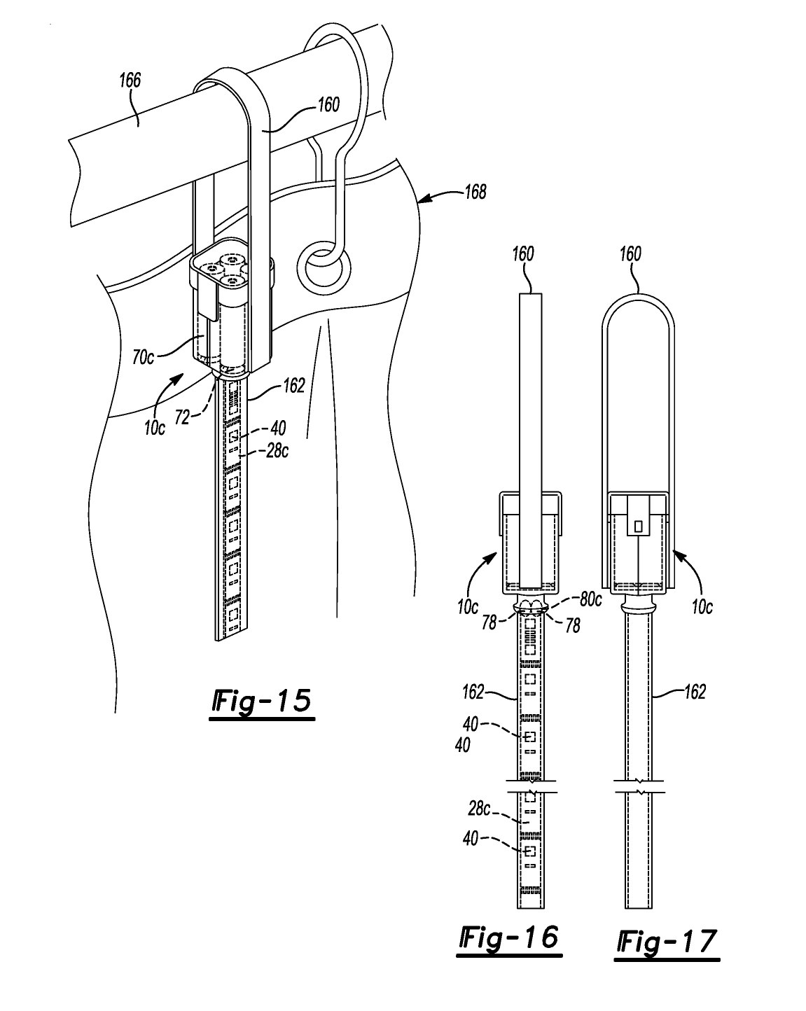

In the example of FIG. 15 through 17, the chromotherapy device 10c comprises a light array 28c, a battery receptacle 70c and a hanger 160. The light array 28c can be similar to the light array 28 (FIG. 2) described above, except that it can optionally include a housing structure 162 that is configured to surround the LED devices 40. The housing structure 162 can be of any structural shape, but in the particular example provided, comprises a hollow tube formed of a clear (transparent) plastic material. The battery receptacle 70c can have a first side, which can be coupled to the light array 28c, and a second side from which the hanger 160 can extend. Similar to the battery receptacle 70 of FIG. 2, the battery receptacle 70c is configured to hold at least one battery 72 and includes a pair of receptacle terminals 78 that are electrically coupled to the light array 28c. The hanger 160 is configured to be releasably mounted on/to a shower curtain rod 166. The LED devices 40 and an electrical connection 80c between the battery receptacle 70 and the light array 28c are waterproof.

In the particular example provided, one or more of the chromotherapy devices 10c can be mounted on the shower curtain rod 166 on an interior side of a conventional shower curtain 168 and can be employed to provide the user with a chromotherapy experience while showering.

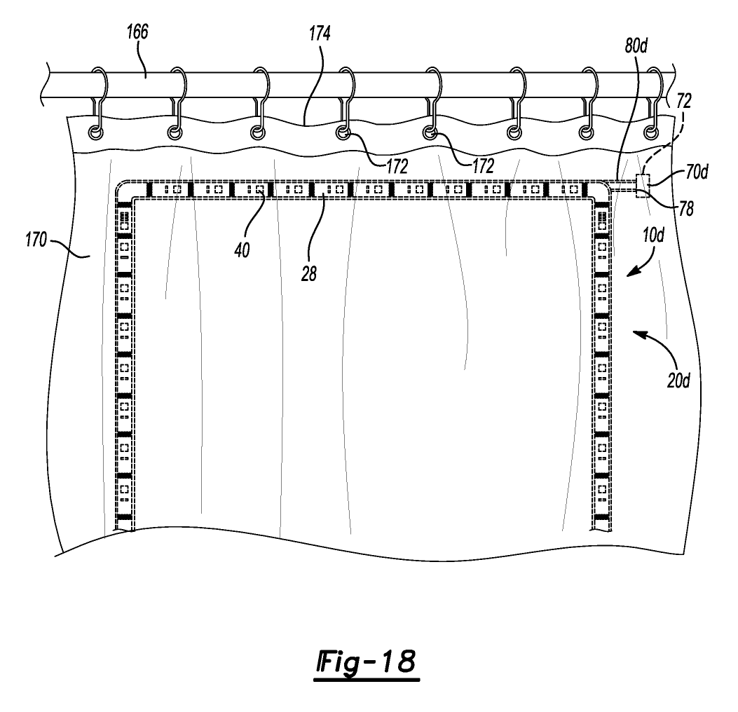

The example of FIG. 18 is similar to the chromotherapy device 10 of FIG. 2, except that the chromotherapy device 10d is configured to be suspended from a shower curtain rod 166. Accordingly, the first device portion 20d can include a curtain 170 in lieu of the flexible mat 26 (FIG. 2). The curtain 170 can include a plurality of spaced-apart holes 172 that are disposed proximate a top edge 174 of the curtain 170. The holes 172 are configured for use in suspending the curtain 170 from the shower curtain rod 166 in a conventional and well known manner. The light array 28 can be mounted onto or disposed in the curtain 170. The battery receptacle 70d is configured to hold at least one battery 72 and includes a pair of receptacle terminals 78 that are electrically coupled to the light array 28. The LED devices 40 and an electrical connection 80d between the battery receptacle 70 and the light array 28 are waterproof.

It will be appreciated that the chromotherapy devices disclosed herein permit the addition of colored lighting into a vessel (e.g., a tub, spa, or shower) without drilling holes and risking water leaks. Additionally, chromotherapy capabilities can be added to a conventional vessel at relatively moderate cost with no modification of existing structures, and in some configurations, no wiring alterations. Additionally, the chromotherapy devices are easily installed and can also be easily removed for cleaning or transporting purposes.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A chromotherapy device for use in a vessel that is configured to contain water, the chromotherapy device comprising:
a first device portion having a flexible mat and a light array, the light array being coupled to the flexible mat and comprising a plurality of LED devices, each LED device having one or more LED's and being configured to selectively generate visible light of a first color, a second color and a third color; and
a second device portion having a battery receptacle that is adapted to hold at least one battery, the battery receptacle having a pair of receptacle terminals that are electrically coupled to the light array;
wherein the LED devices and an electrical connection between the first and second devices are waterproof.

2. The chromotherapy device of claim 1, wherein the battery receptacle comprises first and second receptacle portions that cooperate to define a battery cavity, and wherein the battery receptacle is at least water resistant.

3. The chromotherapy device of claim 2, wherein the battery receptacle is waterproof.

4. The chromotherapy device of claim 1, wherein each LED device comprises a red element, a green element and a blue element.

5. The chromotherapy device of claim 1, wherein the LED devices are dimmable.

6. The chromotherapy device of claim 5, further comprising a controller that is configured to regulate power provided to the LED devices.

7. The chromotherapy device of claim 6, wherein the controller is configured to regulate power provided to each of the LED devices on an individual basis so that certain of the LED devices can be operated independently of other of the LED devices.

8. The chromotherapy device of claim 7, wherein the controller is also configured to control operation of the LED devices so as to affect a color of the light produced by the LED devices.

9. The chromotherapy device of claim 8, wherein the controller is configured to control operation of the LED devices on an individual basis so that the color of the light produced by one of the LED devices can be selected independently of the color of the light produced by other ones of the LED devices.

10. The chromotherapy device of claim 9, further comprising a remote control unit that is configured to wirelessly transmit one or more user commands to the control unit to cause the control unit to operate in one of a plurality of modes of operation, wherein each mode of operation controls color output of the LED devices and/or dimming of the LED devices.

11. The chromotherapy device of claim 6, wherein the controller is also configured to control operation of the LED devices so as to affect a color of the light produced by the LED devices.

12. The chromotherapy device of claim 11, wherein the controller is configured to control operation of the LED devices on an individual basis so that the color of the light produced by one of the LED devices can be selected independently of the color of the light produced by other ones of the LED devices.

13. The chromotherapy device of claim 9, further comprising a remote control unit that is configured to wirelessly transmit one or more user commands to the control unit to cause the control unit to operate in one of a plurality of modes of operation, wherein each mode of operation controls color output of the LED devices and/or dimming of the LED devices.

14. The chromotherapy device of claim 1, wherein the second device portion further comprises a battery that is electrically coupled to the receptacle terminals and wherein the second device portion is disposed within the flexible mat.

15. The chromotherapy device of claim 14, wherein the second device portion further comprises a power unit having a coil, a rectifier and a voltage regulator, the power unit being configured to inductively produce DC electric power when the coil is positioned in a magnetic field so as to be part of an air-core transformer.

16. The chromotherapy device of claim 14, further comprising a second coil that is adapted to produce the magnetic field.

17. The chromotherapy device of claim 1, wherein the flexible mat is formed of a transparent or translucent material and wherein the light array is disposed within the flexible mat.

18. The chromotherapy device of claim 1, wherein the flexible mat comprises at least one suction cup that is adapted to removably secure the first device portion to the vessel.

19. A chromotherapy device for a vessel that is configured to hold water, the chromotherapy device comprising:
a flexible mat;
a light array coupled to the flexible mat and comprising a plurality of LED devices, each LED device having one or more LED's and being configured to selectively generate visible light of a first color, a second color and a third color; and p1 a power unit having a coil, a rectifier and a voltage regulator, the power unit is coupled to the mat and configured to produce DC electric power when the coil is positioned in a magnetic field so as to be part of an air core transformer; and
wherein the LED devices and an electrical connection between the power unit and the LED devices are waterproof.

20. The chromotherapy device of claim 19, further comprising a second coil that is adapted to be coupled to the vessel, the second coil being a primary coil of the air core transformer.

21. The chromotherapy device of claim 20, further comprising a relay coupled to the second coil, the relay being configured to selectively de-couple the second coil from a source of electrical power.

22. The chromotherapy device of claim 21, wherein the relay is a magnetically-actuated relay.

23. The chromotherapy device of claim 22, further comprising a magnet coupled to the flexible mat, the magnet being configured to operate the magnetically-actuated relay.

24. The chromotherapy device of claim 19, further comprising a heating element coupled to the mat and electrically coupled to the coil.

25. The chromotherapy device of claim 19, wherein each LED device comprises a red element, a green element and a blue element.

26. The chromotherapy device of claim 19, wherein the LED devices are dimmable.

27. The chromotherapy device of claim 26, wherein the first device portion further comprises a controller that is configured to regulate power provided to the LED devices.

28. The chromotherapy device of claim 27, wherein the controller is configured to regulate power provided to each of the LED devices on an individual basis so that certain of the LED devices can be operated independently of other of the LED devices.

29. The chromotherapy device of claim 28, wherein the controller is also configured to control operation of the LED devices so as to affect a color of the light produced by the LED devices.

30. The chromotherapy device of claim 29, further comprising a remote control unit that is configured to wirelessly transmit one or more user commands to the control unit to cause the control unit to operate in one of a plurality of modes of operation, wherein each mode of operation controls color output of the LED devices and dimming of the LED devices.

31. The chromotherapy device of claim 27, wherein the controller is also configured to control operation of the LED devices so as to affect a color of the light produced by the LED devices.

32. The chromotherapy device of claim 31, wherein the controller is configured to control operation of the LED devices on an individual basis so that the color of the light produced by one of the LED devices can be selected independently of the color of the light produced by other ones of the LED devices.

33. The chromotherapy device of claim 32, further comprising a remote control unit that is configured to wirelessly transmit one or more user commands to the control unit to cause the control unit to operate in one of a plurality of modes of operation, wherein each mode of operation controls color output of the LED devices and dimming of the LED devices.

34. A chromotherapy accessory for hanging from a shower curtain rod, the chromotherapy accessory comprising:
a light array comprising a plurality of LED devices, each LED device having one or more LED's and being configured to selectively generate visible light of a first color, a second color and a third color;
a battery receptacle mounted to the light array, the battery receptacle being adapted to hold at least one battery, the battery receptacle having a pair of receptacle terminals that are electrically coupled to the light array; and
a hanger mounted to the battery receptacle so as to extend from the battery receptacle on a side that is opposite the light array, the hanger being configured to be mounted on the shower curtain rod;
wherein the LED devices and an electrical connection between the battery receptacle and the light array are waterproof.

35. A chromotherapy curtain for shrouding a showering area, the chromotherapy curtain comprising:
a curtain defining a plurality of spaced-apart holes disposed proximate a top edge of the curtain;
a light array coupled to the curtain and comprising a plurality of LED devices, each LED device having one or more LED's and being configured to selectively generate visible light of a first color, a second color and a third color; and
a battery receptacle that is adapted to hold at least one battery, the battery receptacle having a pair of receptacle terminals that are electrically coupled to the light array;
wherein the LED devices and an electrical connection between the battery receptacle and the light array are waterproof.
